(19) United States
(12) Patent Application Publication
(10) Pub. No.: US 2017/0312790 A1
(43) Pub. Date: Nov. 2, 2017

(54) EJECTOR FOR GRANULAR MATTER COLOR SORTER

(71) Applicants: SATAKE CORPORATION, Tokyo (JP); MECHANO TRANSFORMER CORPORATION, Tokyo (JP); KURODA PNEUMATICS LTD., Asahi-shi, Chiba (JP)

(72) Inventors: Takafumi ITO, Tokyo (JP); Hidehiko MIZUKAMI, Asahi-shi (JP); Toshitada HIRATA, Asahi-shi (JP); Sze Keat CHEE, Tokyo (JP); Toshiro HIGUCHI, Tokyo (JP)

(73) Assignees: SATAKE CORPORATION, Tokyo (JP); MECHANO TRANSFORMER CORPORATION, Tokyo (JP); KURODA PNEUMATICS LTD., Asahi-shi, Chiba (JP)

(21) Appl. No.: 15/531,823

(22) PCT Filed: Nov. 18, 2015
(86) PCT No.: PCT/JP2015/082460

§ 371 Date: May 31, 2017

(30) Foreign Application Priority Data
Dec. 2, 2014 (JP) 2014-243908

(51) Int. Cl. B07C 5/36; B07C 5/342

(52) U.S. Cl. CPC B07C 5/366; B07C 5/3422; B07C 5/3425

(57) ABSTRACT

An ejector for a granular matter color sorter reducing burdens such as cleaning and maintenance in particular associated with a nozzle unit is to be provided. The ejector 10 comprises a nozzle unit 15, a solenoid valve unit 13, and a manifold unit 14. The nozzle unit 15 is constituted by a plurality of nozzle devices 16 that are independent from each other. The solenoid valve unit 13 is constituted by a plurality of solenoid valve devices 19. The respective nozzle devices 16 and the respective solenoid valve devices 19 correspond to each other on a one-on-one basis so that air flow passages of them are connected by an air flow passage of a manifold. The nozzle device 16 and the manifold 29 are detachably connected and made integral in a state where a surface of the nozzle device 16 in which the air flow passage opens and a surface of the manifold 29 in which the air flow passage opens are brought into abutment with each other.

### TECHNICAL FIELD

The present invention relates to an ejector for use in a granular matter color sorter.

### BACKGROUND ART

A granular matter color sorter is adapted to sort out or separate a target granular matter from a large quantity of granular matter based on its color.

For example, as disclosed in Patent Literatures 1 and 2 recited hereinafter, the sorters of this kind may be used for sorting granular matter into good items and defective items and/or removing foreign substance mixed in with the granular matter. The sorting operation of the granular matter is effected by illuminating the granular matter released into the air from an end of a chute or a belt with light, detecting a reflected or transmitted light from the granular matter (including differences in color, brightness, etc.) with a sensor with a sensor, comparing the detected signal with a reference value, to discriminate the good items (or defective items) and/or foreign substance, blowing off the good items (or defective items) and/or the foreign substance by an air jet delivered from a nozzle on the ejector.

Granular matter is a generic term referring to grains, finely chopped vegetables, coffee beans, jewel beads, resin pellets, and other granular matter, and the sorting refers to separation of a unnecessary or necessary granular matter or matter mixed in with a large quantity of granular matter.

### CITATION LIST

### Patent Literature

[Patent Literature 1] Japanese Patent Laid-Open No. H5-146764
[Patent Literature 2] Japanese Patent Laid-Open No. 2012-035185

### SUMMARY OF INVENTION

### Technical Problem

Such an ejector for a granular matter color sorter basically includes a solenoid valve, a manifold, and a nozzle unit, and has a structure according to which high-pressure air filling up the space of the manifold is supplied to the nozzle by actuating the solenoid valve at a set timing to provide an air jet.

In this case, with regard to the ejector, the opening of the nozzle is small, in addition to which the ejector tends to attract dust from its environment due to static electricity caused by friction between the small opening of the nozzle and the air jet flowing therethrough. Further, dust tends to be lifted in the flow passage as a result of dropping of the granular matter, so that it is necessary to conduct periodical cleaning in order to maintain normal operations.

With regard to the periodical cleaning, approaches such as those disclosed in Patent Literatures 1 and 2 or the like have been proposed and adopted.

In the granular matter color sorter of Patent Literature 1, an examination bar 44 which is recognized by the optical sensor 21 as a grain of different color and an air jet detector 52 are provided, and it is sequentially determined whether or not the air jet from air jet ports J1, J2 . . . are normal.

In the color sorter of Patent Literature 2, a nozzle unit and the manifold unit are configured such that it can be disassembled therefrom, and the nozzle unit is configured such that it can be disassembled into a nozzle upper component and a nozzle lower component. According to Patent Literature 2, an air sweeper 23 is mounted thereon, by virtue of which raw materials, dust, and the like deposited upon the nozzle unit upper surface are automatically swept, and the burden of operators associated with cleaning and maintenance is reduced.

However, when any one of these approaches are adopted, it is necessary to detach the entire nozzle unit even when only one nozzle malfunctions among many nozzles arranged in or on the nozzle unit and re-assemble the nozzle unit after the cleaning, which requires time and labor. Also, it may be necessary to re-adjust the position of the nozzle unit as a whole after having re-assembled.

A problem addressed by the present invention is to reduce the burden of cleaning and/or maintenance operation associated with an ejector for a granular matter color sorter, in particular associated with a nozzle unit.

### Solution to Problem

### <Solution 1>

An ejector for a granular matter color sorter comprises a nozzle unit including a plurality of nozzle devices, a solenoid valve unit including a plurality of solenoid valve devices, and a manifold unit including a manifold.

With regard to the respective nozzle devices of the nozzle unit, a nozzle hole opens at a tip end of each nozzle device, and an air flow passage in communication with the nozzle hole is formed therethrough.

Each of the solenoid valve devices is in communication with an air space in which high-pressure air is supplied.

The manifold unit is a portion of the manifold the internal space of which is supplied the high-pressure air, and has a plurality of air flow passages supplying the high-pressure air into the air flow passage of the nozzle device from the solenoid valve device in accordance with the operation of the solenoid valve device.

In addition, each nozzle device corresponds respectively to each solenoid valve device and the nozzle devices are independent from each other, and the nozzle devices are detachably attached to and made integral with the manifold of the manifold unit in a state where a surface of the nozzle device where the air flow passage opens and a surface of the manifold unit where the air flow passage opens are brought into abutment with each other.

### <Solution 2>

The nozzle device may be configured such that it is secured by positioning by one screw relative to the manifold of the manifold unit and a mechanism of attitude definition by the shape of the nozzle device.

### <Solution 3>

A screw head of the screw securing the nozzle device relative to the manifold is consealed from an outside by an openable cover consealing a threaded hole provided in the nozzle.

### <Solution 4>

The nozzle device may have a structure including a lower component and an upper component laid on each other such that the lower and upper components define a nozzle hole and an air flow passage in communication with the nozzle hole.

### <Solution 5>

The nozzle device may have a structure including the lower and upper components laid on each other and secured by a screw so as to be separable from each other.

### <Solution 6>

The plurality of solenoid valve devices may be arranged in multiple rows in a state where phases of arrangement in the rows of the solenoid valve devices are deviated with respect to the manifold unit.

### Advantageous Effects of Invention

According to Solution 1, each nozzle device of the ejector correspond respectively to each solenoid valve device, and the nozzle devices are independent from each other and the nozzle device is integrated with the manifold unit such that it is attachable to and detachable from the manifold unit in a state where the surface in the nozzle device where the air flow passage opens and the surface in the manifold unit where the air flow passage opens are brought into abutment with each other, so that it is made possible to detach only the nozzle that requires inspection and cleaning from the manifold. Also, the indispensable adjustment after the re-attachment is to be effected only on the nozzle that has been subjected to the inspection and cleaning, and thus the labor for inspection and cleaning is reduced.

According to Solution 2, since the attachment and detachment of the nozzle is easy, the time and labor required in inspection and cleaning of the nozzle are further reduced.

According to Solution 3, since accumulation of dust in narrow and hard to see portion such as a threaded hole can be avoided, the time and labor required in the inspection and cleaning of the nozzle are further reduced. Also, it is made possible to prevent situations such as degradation of the color sorting accuracy due to the unexpectedly dispersed dust deposited on the threaded hole.

According to Solution 4, manufacturing of the nozzle device is made simple, which leads to cost reduction associated with the granular matter color sorting device.

According to Solution 5, since the lower and upper components can be secured by the screw, the attachment and detachment are simplified and the lower component and the upper component can be separated from each other, it is made possible to carry out extensive inspection and cleaning of the air flow passage and the like of the nozzle device.

According to Solution 6, it is made possible to arrange more nozzles (nozzle holes) regarding the manifold of the same length than in a case where the solenoid valve devices are arranged along one single line.

### BRIEF DESCRIPTION OF DRAWINGS

FIG. 1 is a diagram of a mechanism of a granular matter color sorting device.

FIG. 2 is a perspective view of an ejector viewed from the bottom left.

FIG. 3 is a perspective view of a solenoid valve device viewed from the upper right.

FIG. 4 is an exploded perspective view of the solenoid valve device.

FIG. 5 is a perspective view of a nozzle unit and a manifold unit viewed from the bottom left.

FIG. 6 is a schematic cross-sectional view illustrating the inside of the nozzle unit and the manifold unit.

FIG. 7 is an exploded perspective view of nozzle device.

FIG. 8 is an enlarged exploded perspective view of nozzle device.

FIG. 9 is an exploded perspective view of one single nozzle device removed from the manifold.

### DESCRIPTION OF EMBODIMENT

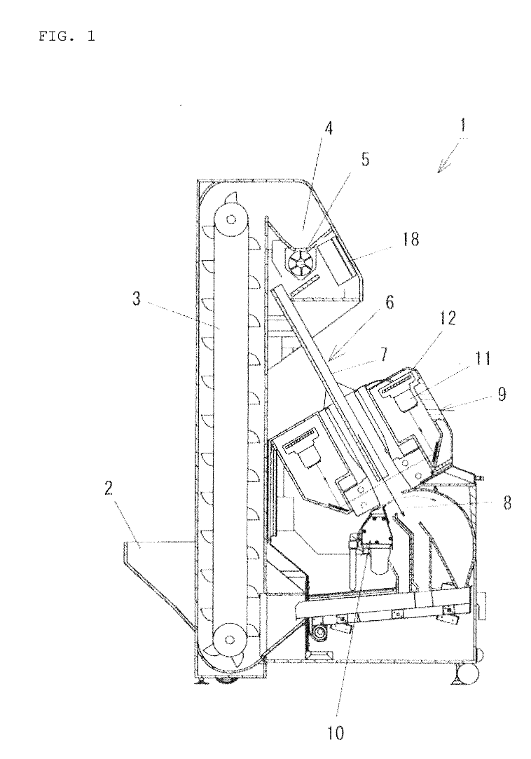

FIG. 1 illustrates mechanical aspects of a granular matter color sorter 1 in its entirety. Granular matter that has been introduced from an throwing-in hopper 2 is conveyed by a bucket conveyor 3 to an upper reservoir tank 4. The granular matter in the reservoir tank 4 is supplied via a rotary valve 5 to an inclined chute 6. The inclined chute 6 of a predetermined width includes a plurality of parallel gutters 7 extending in a longitudinal direction (vertical direction).

The granular matter flows down in a row along the gutters 7 of the inclined chute 6. At the lower end portion of the gutters 7, it flows down at predetermined intervals and is released into the air at the lower end of the inclined chute 6 (the end portion of the conveying unit).

An optical detection device 9 is provided to face the fall path 8 of the granular matter, and an ejector 10 is provided immediately below the optical detection device 9.

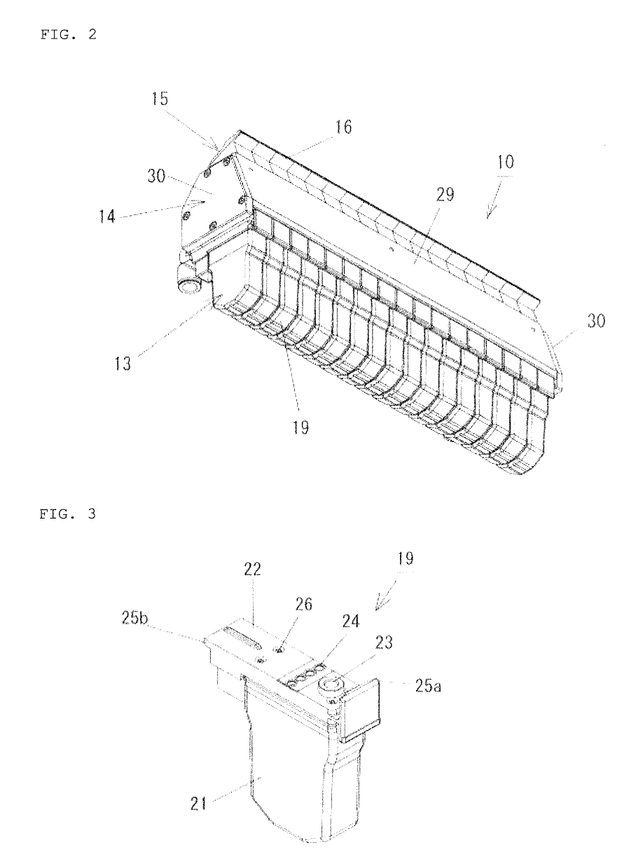

The optical detection device 9 includes cameras 11, a plurality of color sensors 12, an illumination unit, and a background unit, and the ejector 10 (FIG. 2) including a plurality of solenoid valve units 13, a manifold unit 14, and a nozzle unit 15. The nozzle unit 15 comprises a plurality of nozzle devices 16.

The number of the gutters of the inclined chute 6, the number of the color sensors 12 of the optical detection device 9, and the number of solenoid valves 17 (FIG. 4) of the solenoid valve unit 13 correspond to each other on a one-on-one basis, a signal of the color sensor 12 is transmitted to a control device 18, and the solenoid valve 17 opens or closes the valve in response to an instruction of a control device 18.

In this granular matter color sortor 1, the color of each granular matter left the inclined chute 6 (grain to be sorted) is detected respectively by the color sensor 12 of the optical detection device 9, a signal identifying the color thereof is sent to the control device 18, and whether the individual pieces of granular matter are those having the color that corresponds to that of the granular matter to be sorted (target grain) or those whose color does not correspond to it (non-target grain) is determined by the control device 18. If it is determined as being the target grain, then the corresponding one of the solenoid valves 17 of the ejector 10 is opened to deliver an air jet from the corresponding one of the nozzle devices 16 of the solenoid valve unit 13. In addition, this target grains are separated from the non-target grains by the energy of the air jet and then collected.

It should be noted that, in the operation of removing grans of a different color or colors and obtaining regular grains (screened grains), where the mass of granular matter is rice grains, the rice grains are defined as the grains to be sorted, and the grains of the different color(s) are defined as the target grains, and the regular grains are defined as the non-target grains.

FIG. 2 illustrates the ejector 10 comprising the solenoid valve unit 13, the manifold unit 14, and the nozzle unit 15.

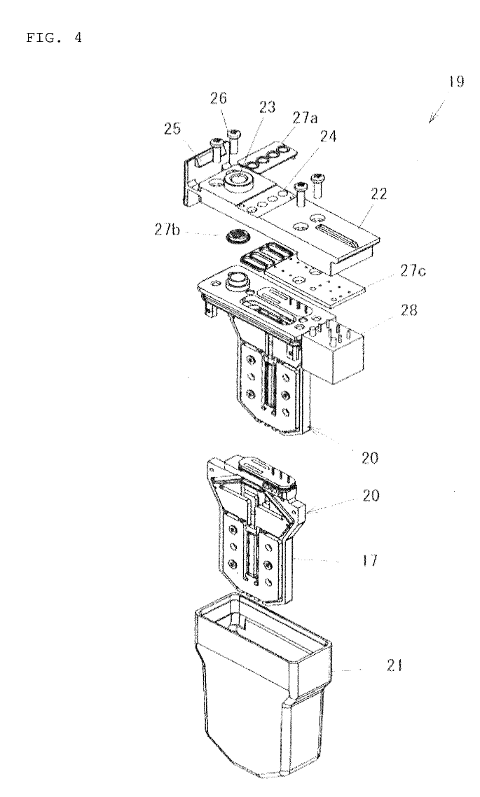

The solenoid valve unit 13 is constituted by a plurality of solenoid valve devices 19. With regard to the respective solenoid valve devices 19, as illustrated in FIGS. 3 and 4, two valve units 20 defined by a pair of the solenoid valves 17 are accommodated in a case 21, which is tightly sealed by a lid member 22. The lid member 22 is provided with an inlet port 23 of high-pressure air, valve-side openings 24 to the nozzle devices 16, an attachment-engagement parts 25 to be engaged with the manifold unit 14, and the like.

The interior space of the case 21 sealed by the lid member 22 is filled with the high-pressure air supplied from the inlet port 23. The air flow passages extending from the solenoid valves 17 to the valve-side openings 24 are provided independently in each of the four solenoid valves 17 inside of the case 21. Specifically, one solenoid valve device 19 includes four valve-side openings 24 corresponding respectively to each of the four solenoid valves 17 on a one-on-one basis. It should be noted that the solenoid valves 17 illustrated in FIG. 4 are a piezoelectric valve that opens or closes the valve under the piezoelectric effect.

In FIG. 4, the reference sign 26 denotes screws connecting the lid member 22 to two pairs of the valve units 20, i.e. four solenoid valves 17 separated in an airtight manner. The reference signs 27a to 27c denote packings for maintaining the air-tightness, and the reference sign 28 denotes a connector to the control device 18.

Also, the outer surface of the lid member 22 defines an attachment surface to attach the solenoid valve device 19 to a manifold 29 (to be described later) of the manifold unit 14.

The plurality of solenoid valve devices 19 are of the same arrangement.

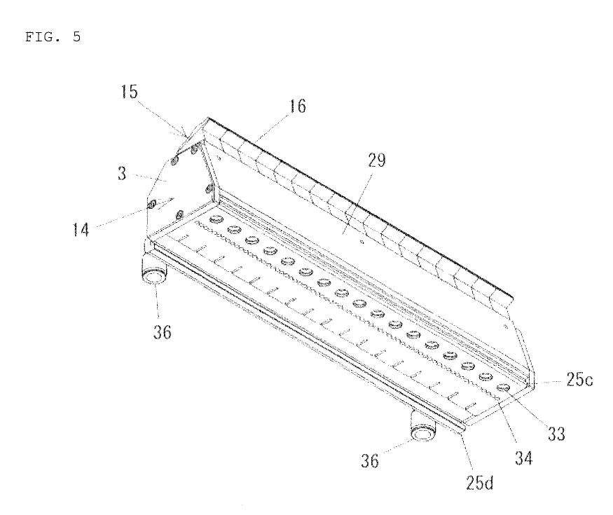

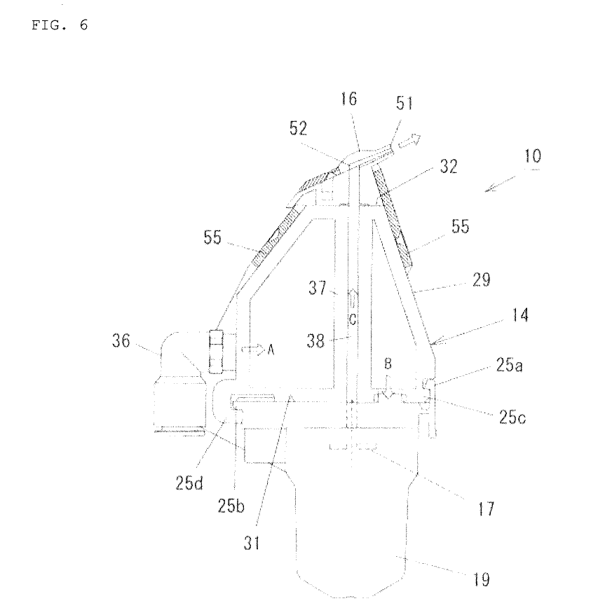

The manifold unit 14 is defined by a hollow cylindrical body (the manifold 29) and covers 30 attached to the opposite longitudinal ends of it, the inside of which is sealed hermetically. The manifold 29 has a flat bottom surface 31 and a flat upper surface 32, and the bottom surface 31 is defined as an attachment surface to attach the solenoid valve devices 19 thereto, and the upper surface 32 is defined as the attachment surface to attach the nozzle devices 16. Attachment reception parts 25c, 25d for bringing the solenoid valve devices 19 into engagement with the bottom surface 31 to attach the solenoid valve devices 19 to the bottom surface 31 are formed in the forward and rear edges in the longitudinal direction (FIGS. 5 and 6).

A supply port 33 of the high-pressure air and a manifold-lower-surface-side opening 34 aligned in the longitudinal direction of the manifold 29 are formed through the bottom surface 31 of the manifold 29. The number of the supply ports 33 is identical with the number of the solenoid valve devices 19 attached to the bottom surface 31, and the number of the manifold-lower-surface-side openings 34 is four times as large as that. Four manifold-lower-surface-side openings 34 are provided for one supply ports 33.

On the upper surface 32 of the manifold 29, manifold-upper-surface-side openings 35 aligned in the longitudinal direction of the manifold 29 are formed therethrough.

Also, on the backside of the manifold 29, a pair of high-pressure air supply pipes 36 are provided on the opposite longitudinal ends in the manifold 29. These pipes 36 are coupled to an independently arranged air compressor.

The manifold 29 is provided in its inside a separation wall 37 extending from the bottom surface 31 to the upper surface 32, through which a manifold side air flow passages 38 extend. The lower end of each air flow passage 38 is the manifold-lower-surface-side opening 34 and the upper end thereof is the manifold-upper-surface-side opening 35.

Also, the inner space (air space) positioned around the separation wall 37 inside of the manifold 29 is in communication with the high-pressure air supply pipes 36 and always filled with the high-pressure air.

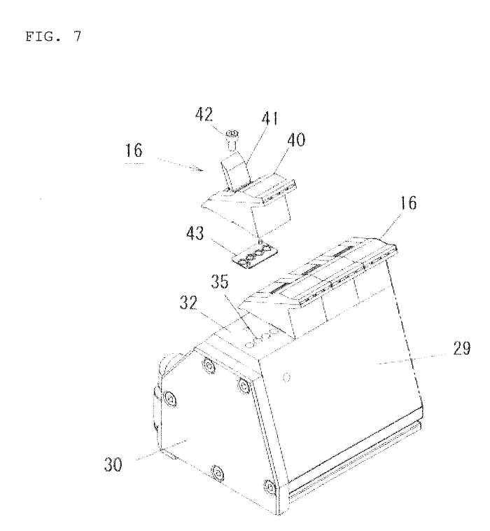

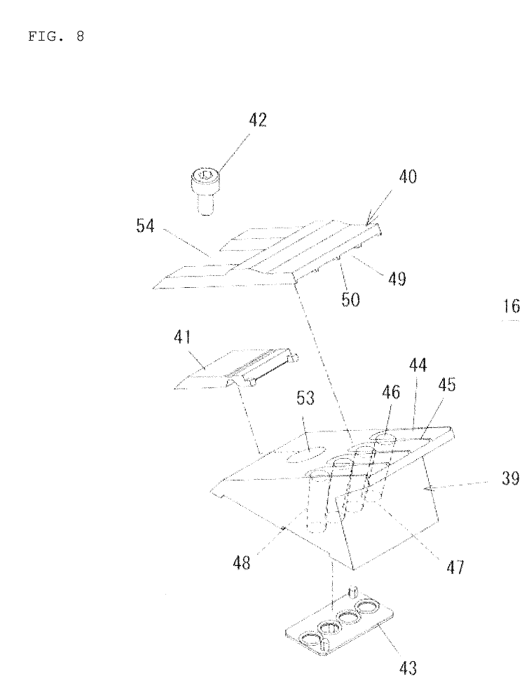

The nozzle device 16 has a lower component 39, an upper component 40, a cover member 41, and a screw 42 (FIGS. 7 and 8). The reference sign 43 denotes a packing, where the lower component 39 and the upper component 40 are laid on and adhered and fixed to each other. In addition, these components are put together to be an integral unit and secured to the upper surface 32 of the manifold 29 by the screw 42. The nozzle device 16 can be adjusted in its position on the upper surface of the manifold 29 by screw 42. The portion of the rear lower surface of the nozzle device 16 in contact with the rear edge of the manifold 29 defines the attitude (rotation, inclination) of the nozzle device 16 with respect to the manifold 29. Specifically, the position of the nozzle device 16 with respect to the manifold 29 is adjusted and secured by one screw and the mechanism for defining the attitude of the nozzle device by the shape thereof.

Four lower grooves 44 are formed at the front edge side upper surface of the lower component 39 and lower separation projections 45 are also formed between the lower grooves 44. The lower groove 44 gradually becomes shallow and closed at the rear end thereof while the front end is opened. Also, nozzle-side upper openings 46 are provided at the base portions of the respective lower grooves 44, and nozzle-side lower openings 47 are provided in the lower surface of the lower component 39. Each of the nozzle-side upper opening 46 is in communication with each nozzle-side lower opening 47 respectively via the nozzle-side air flow passages 48 extending through the lower component 39.

In the upper component 40 is also provided, in the same or similar manner as in the lower component 39, with the upper grooves 49 and the upper separation projections 50 formed therebetween. The front end of each upper groove 49 is opened whilst the base portion thereof is closed. Accordingly, when the lower component 39 and the upper component 40 are laid on each other, four nozzle holes 51 are formed at the front end, and a jet flow passage is formed by the lower groove 44 and the upper groove 49 (FIG. 6).

Also, at the rear portion of the lower component 39 is provided with a threaded hole 53 for the screw 42 extending downwardly from the upper surface thereof. The rear portion of the upper component 40 has a rectangular notch 54 at its center from the rear side.

The threaded hole 53 is defined to have the depth sufficient to conseal the head of the screw 42 therein, and the upper portion of the threaded hole 53 is enlarged in its diameter to accomodate the head of the screw 42.

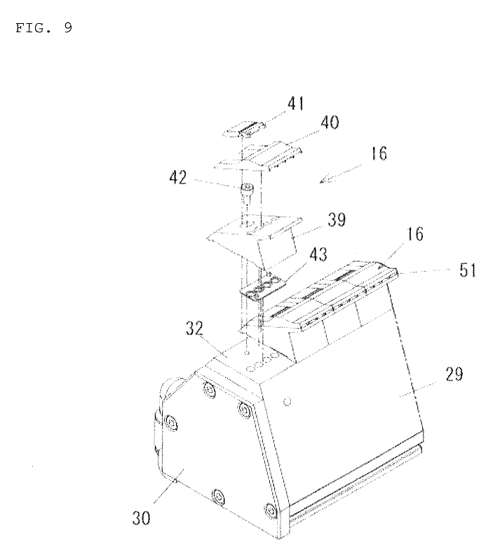

The notch 54 is adapted for remain exposed the threaded hole 53 of the lower component 39 to the upper side. In addition, a cover member 41 is attached such that the notch 54 is closed, the cover member 41 being adapted to be opened or closed with its side of the front-edge side serving as the axis (FIG. 9). The cover member 41 is normally closed.

The solenoid valve device 19 is attached to the bottom surface 31 of the manifold 29, and the nozzle device 16 is attached to the upper surface 32 of the manifold 29. In this state, the space of each solenoid valve 17 of the solenoid valve device 19 in the interior space of the case 21 and the nozzle hole 51 of the nozzle device 16 are brought into communication with each other through the valve-side opening 24, the manifold-lower-surface-side opening 34, the manifold side air flow passage 38, the manifold-upper-surface-side opening 35, the nozzle-side lower opening 47, the nozzle-side air flow passage 48, the nozzle-side upper opening 46, and the jet flow passage 52. Accordingly, the high-pressure air is at first introduced from the high-pressure air supply pipes 36 into the space of the manifold 29 (FIG. 6, the arrow A). The high-pressure air is then introduced from the supply port 33 in the lower surface of the manifold 29 into the case 21 of the solenoid valve device 19 (arrow B). Upon opened the solenoid valve 17, the high-pressure air flows from the valve-side opening 24 into the manifold side air flow passage 38 (arrow C), passed through the jet flow passage 52 and ejected from the nozzle hole 57 in the form of air jet.

The target grain is blown off toward a position that is different from that of the non-target grain and thus separated by adjusting the timing of this jet to coincide with the timing at which the target grain passes the fall path 8.

The plurality of nozzle devices 16 are of the same structure and the solenoid valve devices 19 are also of the same structure, and they are attached in substantially the same or similar manner to the manifold 29.

It should be noted that the reference sign 55 in FIG. 6 denotes an attachment, which is illustrated in its cross section. The attachment 55 is for use in securing the ejector 10 to the body of the granular matter color sorter 1.

When the cleaning of the nozzle device 16 is necessitated, the cover member 41 is opened to expose the head of the screw 42, and the screw 42 is removed through an appropriate tool. Upon disengaged the attachment-engagement parts 25a, 25b from the attachment-reception parts 25c, 25d on the side of the manifold 29, the nozzle device 16 can be readily detached from the upper surface of the manifold 29.

Since the nozzle devices 16 can be detached individually from the manifold 29, the long and cumbersome manifold unit 14 does not interfere the cleaning of the nozzle devices 16. As a result, cleaning operations can be performed easily. Also, since it is made possible to detach only the nozzle device 16 whose inspection and cleaning is necessary and perform the operations therefor, the efficiency of the inspection and cleaning is increased.

In addition, in this embodiment, since the screw 42 that secures the nozzle device 16 to the manifold 29 is shielded from the outside using the cover member 41, dust does not accumulate at the location where the screw 42 is attached. As a result, it is made possible to prevent situations such as negative impacts upon the color sorting accuracy due to the dust accumulated on the threaded hole unexpectedly dispersed again therefrom.

The embodiment has been described in the foregoing.

The lower component 39 and the upper component 40 of the nozzle device 16 may be laid on each other and secured to each other by a screw such that these members can be separated from each other.

In this case, when inspection and cleaning are to be carried out, the lower component 39 and the upper component 40 can be separated from each other and the inside of the jet flow passage 52 can be subjected to extensive inspection and cleaning.

The shapes of the nozzle device 16, the manifold 29, the solenoid valve device 19, and the like of the ejector 10, or the number of the nozzle holes 51, are not limited to those of the embodiment.

The shapes and the number recited above may be adjusted as appropriate in accordance with the structure and the location of installation of the granular matter color sorting device 1 for which the ejector 10 is incorporated.

The solenoid valve device 19 is configured by the solenoid valves 17 such that one solenoid valve device 19 includes, though not limited to, four solenoid valves 17.

Although the solenoid valve 17 is illustrated by way of example as one that uses the piezoelectric effect, the solenoid valve 17 may be any one that uses any other electromagnetic effects.

### INDUSTRIAL APPLICABILITY

The present invention is applicable to an ejector for a granular matter sorting device.

### REFERENCE SIGNS LIST

1 Granular matter color sorter
2 Throwing-in hopper
3 Bucket conveyor
4 Reservoir tank
5 Rotary valve
6 Inclined chute
7 Gutters
8 fall path
9 Optical detection device
10 Ejector
11 Camera
12 Color sensor
13 Solenoid valve unit
14 Manifold unit
15 Nozzle unit
16 Nozzle device
17 Solenoid valve
18 Control device
19 Solenoid valve device
20 Valve unit
21 Case
22 Lid member
23 Inlet port
24 Valve-side opening
25a, 25b Attachment-engagement part
25c, 25d Attachment-reception part
26 Screw
27a, 27b, 27c Packing
28 Connector
29 Manifold
30 Cover
31 Bottom surface
32 Upper surface
33 Supply port
34 Manifold-lower-surface-side opening
35 Manifold-upper-surface-side opening
36 High-pressure air supply pipe
37 Separation wall
38 Manifold side air flow passage
39 Lower component
40 Upper component
41 Cover member
42 Screw
43 Packing
44 Lower groove
45 Lower separation projection
46 Nozzle-side upper opening
47 Nozzle-side lower opening
48 Nozzle-side air flow passage
49 Upper groove
50 Upper separation projection
51 Nozzle hole
52 Jet flow passage
53 Threaded hole
54 Notch

1. An ejector for a granular matter color sorter that carries out detection of granular matter fallen from an end of a conveying unit at a predetermined position, and removes the granular matter by an air jet on the basis of a result of the detection, the ejector comprising:
a nozzle unit including a plurality of nozzle devices each having a nozzle hole opening at a tip end thereof and an air flow passage formed therein and in communication with the nozzle hole opening;
a solenoid valve unit in which an air space in communication with a high-pressure air source is formed, the solenoid valve unit being constituted by a plurality of solenoid valve devices in communication with the air space; and
a manifold unit having a manifold including a plurality of air flow passages for supplying high-pressure air to the respectively corresponding air flow passages of the nozzle unit by the operation of the respective solenoid valve devices, wherein each nozzle device corresponds respectively to each solenoid valve devices and the nozzle devices are independent from each other, and the nozzle devices and the manifold are attached and made integral such that they are detachable from each other in a state where a surface of the nozzle device in which the air flow passage opens and a surface of the manifold in which the air flow passage opens are brought into abutment with each other.

2. The ejector of the granular matter color sorter according to claim 1, wherein the nozzle device is secured by positioning by a screw relative to the manifold and a mechanism of attitude definition by the shape of the nozzle device.

3. The ejector of the granular matter color sorter according to claim 2, wherein a screw head of the screw securing the nozzle relative to the manifold is consealed from an outside by an openable cover consealing a threaded hole provided in the nozzle.

4. The ejector of the granular matter color sorter according to claim 1, wherein the nozzle device includes a lower component and an upper component laid on each other such that the lower and upper components define a nozzle hole and an air flow passage in communication with the nozzle hole.

5. The ejector of the granular matter color sorter according to claim 4, wherein the lower component and the upper component are separable because of their connection through the screw.

6. The ejector of the granular matter color sorter according to claim 1, wherein the plurality of solenoid valve devices are arranged in multiple rows in a state where phases of arrangement in the rows of the solenoid valve devices are deviated with respect to the manifold.
